(19) United States
(12) Patent Application Publication
(10) Pub. No.: US 2009/0202862 A1
(43) Pub. Date: Aug. 13, 2009

(54) ELECTROPLATED DEVICE AND PREPARATION METHOD THEREOF

(76) Inventors: Liang Chen, Shenzhen (CN); Qing Gong, Shenzhen (CN); Yunbo Yi, Shenzhen (CN); Fang Liu, Shenzhen (CN)

Correspondence Address: BRINKS HOFER GILSON & LIONE, P.O. BOX 10395, CHICAGO, IL, 60610, US

(21) Appl. No.: 12/305,142

(22) PCT Filed: May 28, 2007
(86) PCT No.: PCT/CN2007/001710

§ 371 Date: Dec. 16, 2008

(30) Foreign Application Priority Data
Jun. 26, 2006 (CN) 200610086789.2

(51) Int. Cl. B32B 15/01; C25D 5/10

(52) U.S. Cl. 428/674; 205/176; 205/182

(57) ABSTRACT

Disclosed is an electroplated product, comprising a base material and an electroplated metal layer including a copper layer on the surface of the base material, wherein the electroplated metal layer further includes a nickel substitute metal layer on the copper layer and the nickel substitute metal is Cu—Sn alloy, Ru, Rh, Pd, or an alloy composed of 2, 3, or 4 elements selected from Ru, Rh, Pd, and Co. A method for preparing the same is also disclosed. The metal electroplated layer of said electroplated product is free of nickel, and therefore will not cause nickel irritation on skin. Furthermore, the electroplated layer also has the advantages of nickel coating, including good smoothness, brightness, wearing resistance, corrosion resistance, and thermal shock resistance, etc.

### FIELD OF THE INVENTION

The present invention relates to an electroplated product and a preparation method thereof.

### BACKGROUND OF THE INVENTION

Electroplated metallic or non-metallic products not only have excellent appearance but also obtain a plating layer that decorates and protects the base material. For example, plastic products are featured with light weight, good plasticity, and fine and smooth surface, etc., and can be formed into different shapes as required. Compared with ordinary plastic materials, electroplated plastic products have better decorative performances, surface gloss and flatness, and are easier to be processed. Therefore, they are widely applied in automobiles, motorcycles, hardware, and daily home appliances.

The traditional plastic electroplating process employs metallic nickel. Due to its good decorative and protective performances, nickel plated layer has been widely used. Furthermore, the nickel plating layer can also effectively prevent diffusion of metals from the lower metal layer to the upper metal layer (e.g., precious metal layer) and vice versa, and thereby can effectively prevent color fading or discoloration of the surface metal, to obtain a plating layer with good brightness. However, it is found that the contact between metallic nickel and skin may cause nickel irritation; therefore, in many countries, such as the countries of European Community, laws have been enacted to restrict the nickel content in jewelries and to restrict the precipitation of metallic nickel from jewelries per cm² per week no more than 0.5 μg. Therefore, it is expected to develop an electroplated product that will not cause irritation when it contacts with skin.

### SUMMARY OF THE INVENTION

An object of the present invention is to overcome the drawback that nickel used in the prior electroplating method may cause nickel irritation when it contacts with skin, and provide an electroplated product that is nickel-free and has a smooth and bright plating layer, as well as a preparation method thereof.

The present invention provides an electroplated product comprising a base material and an electroplated metal layer including a copper layer on the surface of the base material, characterized in that the electroplated metal layer further includes a nickel substitute metal layer on the copper layer and nickel substitute metal is Cu—Sn alloy, Ru, Rh, Pd, or an alloy composed of 2, 3, or 4 elements selected from Ru, Rh, Pd, and Co.

The present invention also provide a method for preparing the electroplated product comprising a step of electroplating a metal on the surface of a base material, wherein the step of electroplating the metal comprises electroplating copper and nickel substitute metal on the surface of the base material in sequence, and the nickel substitute metal is Cu—Sn alloy, Ru, Rh, Pd, or an alloy composed of 2, 3, or 4 elements selected from Ru, Rh, Pd, and Co.

The electroplated metal layer of the electroplated product according to the present invention is free of metallic nickel, and therefore it will not cause skin irritation. Furthermore, the nickel substitute metal layer also has the advantages of nickel coating: smooth coating, prevention of diffusion of metals from the lower metal layer to the upper metal layer and vise versa, prevention of color fading or discoloration of surface metal; therefore, the electroplated metal layer is comparable or superior to nickel coating in terms of brightness, wearing resistance, corrosion resistance, and thermal shock resistance. Especially, if nanometer particles are added into the plating solution in the electroplating procedure for the nickel substitute metal, the nanometer particles can make the obtained electroplated layer more dense, and more wearing resistant and corrosion resistant.

### DETAILED DESCRIPTION OF THE PREFERRED EMBODIMENTS

In the present invention, copper and nickel substitute metal may be electroplated on the surface of base material by any electroplating method. In view that it is much easier to control thickness and quality of the electroplated layers by aqueous electroplating method and the hardness of the product obtained through multi-layer electroplating by aqueous electroplating method is higher, the aqueous electroplating method is preferably used to electroplate metal layers on the surface of the base material.

Usually, the aqueous electroplating method comprises immersing the base material as the cathode in the plating solution and utilizing a metal plate as the anode; and then, switching on a direct current to deposit a metal electroplated layer on the surface of base material. Said metal plate can be a metal plate made of the electroplated metal, a metal plate made of any metal in the electroplated alloy, or a Ru—Ir alloy plate covered by Ti. No matter whatever metal plate is used as the anode, the metal ions in the plating solution can be reduced to the required electroplated metal and deposited on the base material, as long as the metal ions in the plating solution is kept at an appropriate concentration.

In a preferred embodiment of the present invention, in the electroplating procedure for the nickel substitute metal, the base material serves as the cathode, while a Ru—Ir alloy plate covered by Ti serves as the anode. According to such embodiment, by using a Ru—Ir alloy plate covered by Ti as the anode, hydrogen adsorption on the anode can be suppressed, avoid pinholes or cracking on the electroplated layer can be avoided, and the electroplating procedure for the nickel substitute metal is stabler. Said plating solution can be an aqueous solution containing a soluble salt of Ru, Rh, Pd, or 2, 3 or 4 elements selected from Ru, Rh, Pd, and Co, or an aqueous solution containing a soluble salt of Cu and Sn. Said soluble salt is chloride, sulfate, or nitrate.

In the present invention, said nickel substitute metal is preferably Ru, Rh, Pd, Ru—Rh alloy, Pd—Co alloy, or Cu—Sn alloy. The concentration of the nickel substitute metal contained in the nickel substitute metal plating solution is each 0.001-0.5 mol/l.

For example, when Pd is electroplated, said plating solution is preferably a mixed aqueous solution of diammine dichloropalladium (II), ammonium chloride, and ammonia, wherein, the concentration of Pd ion in said plating solution is 0.015-0.03 mol/l, and preferably 0.02-0.03 mol/l, and the pH of said plating solution is 6-9, and preferably 7-8. The resulting Pd electroplated layer serves as an intermediate barrier layer, which can effectively prevent diffusion of metals from the lower metal layer to the upper metal layer.

When Cu—Sn alloy is electroplated, said plating solution is preferably a mixed aqueous solution of copper sulfate and tin sulfite. The concentration of copper ion in said plating solution is 0.1-0.3 mol/l, and preferably 0.15-0.25 mol/l; and the concentration of tin ions is 0.15-0.25 mol/l, and preferably 0.2-0.25 mol/l. The obtained Cu—Sn electroplated layer has good diffusion prevention performances, smooth surface, and fine crystallization.

When Pd—Co alloy is electroplated, said plating solution is preferably an aqueous solution of diammine dichloropalladium (II) and cobaltous chloride. The concentration of Pd ion in said plating solution is 0.01-0.04 mol/l, and preferably 0.02-0.03 mol/l; and the concentration of Co ion is 0.001-0.01 mol/l, and preferably 0.003-0.006 mol/l.

When Rh is electroplated, said plating solution is preferably an aqueous solution of rhodium sulfate; wherein, the concentration of Ru ion in said plating solution is 0.007-0.015 mol/l, and preferably 0.01-0.013 mol/l.

When Ru is electroplated, said plating solution is preferably a mixed solution of nitro-ruthenium chloride and sulfamic acid; wherein the concentration of Ru ion in said plating solution is 0.03-0.05 mol/l, and preferably 0.035-0.045 mol/l.

When Ru—Rh alloy is electroplated, said plating solution is preferably a mixed solution of rhodium sulfate and nitro-ruthenium chloride; wherein the concentration of Ru ion in said plating solution is 0.001-0.01 mol/l, and preferably 0.003-0.007 mol/l; and the concentration of Rh ion is 0.005-0.03 mol/l, and preferably 0.01-0.02 mol/l.

The conditions of the electroplating for said nickel substitute metal are conventional conditions of aqueous electroplating, usually including: temperature of plating solution: 0-60° C., preferably 5-55° C.; and DC current density: 0.2-5 A/dm², preferably 0.25-4 A/dm². There is no special limitation for the electroplating time, as long as the thickness of electroplated layer reaches to the required thickness for each metal electroplated layer. According to the method of the present invention, the obtained nickel substitute metal layer is in a thickness of 0.1-6 μm, and preferably 0.2-4 μm.

In the present invention, unless otherwise specified, said thickness of each metal electroplated layer refers to single-side thickness. The thickness of each metal electroplated layer can be measured with a slicing method, which usually comprises: cutting the electroplated product into a section with a microtome, observing the cross section under a metalloscope, and measuring the thickness of each metal electroplated layer.

In the present invention, said copper electroplating method and conditions are known to those skilled in the art. For example, the base material can be used as the cathode, and a copper plate or a Ru—Ir alloy plate covered by Ti can be used as the anode. Said plating solution usually contains copper pyrophosphate, potassium pyrophosphate, and ammonium citrate; wherein the content of copper pyrophosphate in said plating solution is 40-80 g/l, and preferably 50-70 g/l; the content of potassium pyrophosphate is 250-400 g/l, and preferably 300-350 g/l; and the content of ammonium citrate is 15-30 g/l, and preferably 18-25 g/l. Said plating solution is at a temperature of 30-60° C., and preferably 40-55° C.; and the electroplating time is usually 1-10 min.

Usually, in order to improve thermal shock performances of the electroplated layer, preferably an additional layer of copper is electroplated after a layer of copper is deposited. Said plating solution contains copper sulfate and copper chloride; wherein the content of copper sulfate in said plating solution is 150-300 g/l, and preferably 180-250 g/l; and the content of copper chloride is 120-250 g/l, and preferably 150-200 g/l. Said plating solution is at a temperature of 15-35° C., and preferably 20-30° C.; and the electroplating time is usually 8-15 min.

Finally, the obtained copper electroplated layer is in a thickness of 10-30 μm, and preferably 15-20 μm.

In the present invention, said electroplated metal layer can further comprise a chromium layer, which is on said nickel substitute metal layer. Therefore, after copper and nickel substitute metal are electroplated in sequence on the surface of base material, said metal electroplating process can further comprise a chromium electroplating procedure. Said chromium electroplating method and conditions are known to those skilled in the art. For example, the base material can be used as the cathode, while a carbon plate, chromium plate, or Ru—Ir alloy plate covered by Ti can be used as the anode. Said chromium electroplating comprises electroplating of sexavalent chrome or trivalent chromium.

When sexavalent chrome is to be electroplated, said plating solution usually contains chromic anhydride and concentrated sulfuric acid; wherein the content of said chromic anhydride is 150-300 g/l, and preferably 175-250 g/l; and the content of said concentrated sulfuric acid is 1-3 ml/l, and preferably 1.5-2.5 ml/l. Said plating solution is at a temperature of 25-50° C., and preferably 30-45° C.; and the electroplating time is usually 3-15 min, and preferably 5-12 min.

When trivalent chromium is to be electroplated, said plating solution is usually a mixed aqueous solution of one or more selected from chromium chloride, chromic sulfate, formic acid, and chromic fluoride, and preferably an aqueous solution of chromium chloride. The concentration of chromium ion in said plating solution is 15-30 g/l, and preferably 20-25 g/l. Said plating solution has pH of 2.0-3.5, and preferably 2.5-3.0; the temperature of said plating solution is 20-50° C., and preferably 25-40° C.; and the electroplating time is 1-8 min, and preferably 3-6 min.

Finally, the obtained chromium coating is in a thickness of 0.1-0.5 μm, and preferably 0.2-0.3 μm.

According to the method of the present invention, preferably said plating solution further contains nanometer particles in electroplating procedure for the nickel substitute metal and/or chromium. Said nanometer particles can make the electroplated layer more dense and more wear-resistant and corrosion-resistant. Said nanometer particles can be any particles having a particle diameter at nanometer level, such as one or more selected from diamond particles, aluminum oxide particles, silicon dioxide particles, titanium dioxide particle, and zirconium oxide particles. Said nanometer particles preferably have a particle diameter of 50-200 nm, and more preferably 80-160 nm. The content of said nanometer particle in the plating solution is 5-30 g/l, and preferably 8-20 g/l. In the present invention, before the electroplating, said nanometer particles are added into said plating solution and are agitated homogeneously, so that said nanometer particles suspend in said plating solution homogeneously. Preferably, in order to ensure the nanometer particles can form homogeneously in said metal electroplated layer, said electroplating process is carried out under agitation.

The method of the present invention may further comprise a procedure of drying the base material after metal electroplating. Said drying method and conditions are known to those skilled in the art; for example, the drying temperature ranges from room temperature to 80° C., and the drying time is 10-30 min.

In the present invention, said base material can be conductive material or non-conductive material. For example, said non-conductive material can be plastic, fiber or resin; and said conductive material can be metal material, such as stainless steel, magnesium and aluminium. Said plastic material can be any plastic material that can be used in electroplating or electroless plating, such as acrylonitrile-butadiene-styrene copolymer (ABS), polycarbonate (PC), nylon or polypropylene (PP). Among them, ABS is preferred.

If said base material is a non-conductive material such as plastic material, in order to ensure subsequent copper electroplating, the plastic material is electroless plated with metal such as copper to metallize it before said copper electroplating is carried out.

Usually, said electroless plating method comprises: immersing the base material (e.g., ABS) into a plating solution and adding a reducing agent, to reduce the metal ions of metal salt in the plating solution into simple substance state by the reducing agent and deposit it on the surface of said base material. The conditions of electroless copper plating are known to those skilled in the art; for example, said plating solution can be an aqueous solution containing one or more selected from copper chloride, copper sulfate, and copper oxide; and the concentration of copper ion in said plating solution is 0.01-0.08 mol/l, and preferably 0.04-0.06 mol/l. Said reducing agent can be one or more selected from formaldehyde, dimethylamine borane, hypophosphite, borane, and sugar, and is preferably formaldehyde. The concentration of the reducing agent in said plating solution is 15-40 g/l, and preferably 10-35 g/l. Said plating solution can further contain a complexing agent selected from sodium potassium tartrate, EDTA disodium, citric acid, and triethanolamine, in an amount of 5-40 g/l, and preferably 10-30 g/l. The pH of said plating solution is usually 11-13.5. In view of the poor heat resistance property of plastic material, the temperature of said plating solution is usually set to 20-60° C., in order to prevent deformation of said plastic material; and the time of electroless plating is usually 5-20 min. The electroless plated copper layer obtained is usually in a thickness of 0.1-0.5 μm, and preferably 0.2-0.3 μm.

The method of the present invention further comprises a procedure of base material preprocessing before said base material is metallized. The method and conditions for preprocessing of non-conductive base material are known to those skilled in the art; and usually, said preprocessing method comprises degrease, coarsening, and activation procedures.

For example, for a plastic product, said degrease is to swab the surface of the plastic product with a degrease agent, so as to remove filth (e.g., oil stains) from the plastic product and facilitate to evenly coarsen the surface of said plastic product and prolong the service life of coarsening agent used. The sort and dosage of said degrease agent are known to those skilled in the art. In order to prevent deformation of the plastic product, the degrease temperature is set to 40-80° C., and preferably 50-70° C.; the degrease time is usually 3-15 min., and preferably 5-10 min.

The purpose of coarsening is to introduce hydrophilic groups on the surface of base material to afford hydrophilicity to said base material and form microporous structure on the surface of said base material, in order to ensure activator adsorption capability of said base material when the base material is subjected to colloidal palladium activation, and thereby adhesion of the plated layer is ensured. Said coarsening comprises immersing the deoiled base material into a coarsening solution. The sort and dosage of said coarsening solution are known to those skilled in the art; for example, said coarsening solution contains chromic anhydride at a concentration of 200-500 g/l (preferably 350-450 g/l) and sulfuric acid at a concentration of 200-500 g/l (preferably 350-400 g/l). Said coarsening solution is at a temperature of 50-80° C., and preferably 60-70° C.; and the coarsening time is 5-20 min., and preferably 8-15 min.

Preferably, said coarsening further comprises a neutralization procedure after coarsening. The purpose of neutralization is to remove residual chromic acid solution from the surface of the electroplated work piece, so as to prolong the service life of said activate fluid used subsequently. Said neutralization can be carried out with any acid solution; and in the present invention, preferably hydrochloride acid at pH of 0.5-2.5 is used. The neutralization time is 1-6 min, and the neutralization temperature is preferably room temperature.

Said activation is to enable the porous surface of plastic material after coarsening to absorb the colloidal activator evenly and thereby provide catalytic carrier for the subsequent electroless copper plating. Said activation comprises pre-dipping, colloidal palladium activation, and peptization procedures; and preferably, the pre-dipping, and the colloidal palladium activation are combined.

Said pre-dipping comprises immersing the base material in a pre-dipping solution which can remove impurities from the base material partially, has buffer effect for the activating solution, and prevents the hydrochloric acid in said activate fluid from being diluted as well as destructive hydrolysis resulted from direct contact between the colloid on the surface of base material and the neutral water on the surface of base material after activation. The sort and content of said pre-dipping solution are known to those skilled in the art; for example, said pre-dipping solution is usually a mixed solution of tin salt and hydrochloric acid. Said tin salt is usually tin chloride and/or tin sulfate; and the concentration of tin salt in said pre-soaking solution is 100-300 g/l, and preferably 150-250 g/l. The concentration of hydrochloric acid is usually 20-100 ml/l, and preferably 30-70 ml/l. The pre-soaking time is 1-6 min., and preferably 2-4 min.; and the pre-soaking temperature is preferably room temperature.

Said colloid activation is to immerse the pre-dipping base material into the activating solution directly which is usually a mixed solution of palladium chloride, hydrochloric acid, and tin salt in said pre-dipping solution. The content of palladium chloride in said activating solution is 5-25 g/l, and preferably 7-18 g/l; the concentration of hydrochloric acid is 30-80 ml/l, and preferably 40-60 ml/l; and the content of tin salt is 100-300 g/l, and preferably 150-250 g/l. Said activating solution is at a temperature of 30-50° C., and preferably 35-45° C.; and the activating time is 1-10 min., and preferably 3-8 min.

The core of said colloid absorbed on the surface of plastic material is palladium, embraced by stannous particle cluster. During water washing, the stannous particle cluster can be easily hydrolyzed into colloid, which wraps palladium closely and thereby prevents the catalytic effect of palladium. The purpose of said dispergation is to remove the residual stannous substance from the surface of colloidal agglomerate, so as to expose the palladium activator to serve as active catalytic points in electroless nickel plating. The dispergation method and conditions are known to those skilled in the art. Said dispergation solution is usually hydrochloric acid solution at a concentration of 50-200 ml/l, and preferably 80-150 ml/l; the dispergation time is usually 1-5 min., and preferably 1-3 min; and the dispergation temperature is 30-50° C., and preferably 35-45° C.

Usually, the conductive base material can be electroplated directly after it is degreased.

Preferably, said preprocessing method further comprises a water washing procedure after each procedure, in order to remove residual solution from the surface of base material. The water used in said water washing procedure can be any water in the prior art, such as urban tap water, deionized water, distilled water, purified water, or the mixture thereof; and in the present invention, said water is preferably deionized water.

The method provided in the present invention is especially suitable for producing electroplated products with plastic base material, such as plastic keypads of mobile phones or casings of notebook computers, etc.

Hereunder the present invention will be further described in way of examples.

### Example 1

This example describes the electroplated product and the preparation method provided in the present invention.

### (1) Preprocessing of Base Material

An ABS plastic plate having a dimension of 5 cm×5 cm×0.5 cm (Model No. 0215A, from Jilin Petrochemical) was immersed into degrease solution in volume equal to two times of the size of said plastic plate at 55° C. (said degrease solution contained 25 g/l of sodium hydroxide, 35 g/l of sodium carbonate, 25 g/l of sodium phosphate, and 2 g/l of emulsifying agent OP-10) for 10 min. And then, the ABS plastic plate was taken out, washed with deionized water till no carbon ion was detected in the washing deionized water.

The degreased ABS plastic plate was immersed into the coarsening solution in volume equal to two times of the size of said ABS plastic plate at 55° C. (said coarsening solution contained 350 g/l of chromic anhydride and 350 g/l of sulfuric acid) and coarsened for 8 min. Then, said ABS plastic plate was taken out, and washed with deionized water till no sulfate ion was detected in the washing deionized water.

At room temperature, said coarsened ABS plastic plate was immersed into hydrochloric acid at pH=2.0 in volume equal to two times of the size of said ABS plastic plate for 1 min. and then, taken out and washed with deionized water till no chloride ion was detected in the washing deionized water.

At room temperature, the above ABS plastic plate was immersed into a pre-soaking liquid in volume equal to two times of the size of said ABS plastic plate (said pre-dipping solution contained 150 g/l of tin dichloride and 40 ml/l of hydrochloric acid) for 2 min. Then, an activating solution in volume equal to two times of the size of said ABS plastic plate was added into said pre-dipping solution (said activating solution contained 10 g/l of palladium chloride, 150 g/l of tin dichloride, and 40 ml/l of hydrochloric acid) and mixed homogeneously, to colloidal palladium activate said ABS plastic plate at 35° C. for 3 min. Then, said ABS plastic plate was taken out and washed with water, till there was no residual pre-dipping solution or activating solution on the surface of said plastic plate. Finally, at 35° C., the colloid activated ABS plastic plate was immersed into hydrochloric acid solution at 100 ml/l concentration in volume equal to two times of the size of said ABS plastic plate for 3 min.; and then, taken out and washed with deionized water, till no chloride ion was detected in the washing deionized water, to obtain the activated ABS plastic material.

### (2) Electroless Copper Plating

The ABS plastic plate obtained in procedure (1) was immersed into the plating solution in volume equal to two times of the size of said ABS plastic plate at 30° C. (said plating solution contained 6 g/l of copper chloride, 20 g/l of EDTA disodium, 15 ml/l of formaldehyde, and 10 g/l of sodium potassium tartrate; the concentration of copper ion was 0.04 mol/l; and the pH of said plating solution was controlled to 12 with sodium hydroxide of 50 wt %) to carry out electroless copper plating on said ABS plastic plate for 10 min. And then, the electroless plating was stop, and said ABS plastic plate was taken out, and washed with deionized water till no acid ion was detected in the washing deionized water, to obtain electroless plated copper layer in a thickness of 0.2 μm.

### (3) Copper Electroplating

The ABS plastic plate obtained in procedure (2) was immersed into a plating solution in volume equal to two times of the size of said ABS plastic plate at 55° C. (said plating solution contained 50 g/l of copper pyrophosphate, 300 g/l of potassium pyrophosphate, and 18 g/l of ammonium citrate) as the cathode, and a copper plate was used as the anode. A direct current power was switched on, and the electroplating was carried out at a current density of 3 A/dm² for 5 min. And then, said ABS plastic plate was taken out, and washed with water, till no acid ion was detected in the washing water.

The above ABS plastic plate was immersed into a plating solution in volume equal to two times of the size of said ABS plastic plate at 20° C. again (said plating solution contained 180 g/l of copper sulfate and 150 g/l of copper chloride) as the cathode, and a copper plate was used as the anode. A direct current power was switched on, and the electroplating was carried out at a current density of 3 A/dm² for 8 min. And then, the ABS plastic plate electroplated with copper was taken out, and washed with deionized water, till no acid ion was detected in the washing deionized water, to obtain the electroplated copper layer in a thickness of 15 μm.

### (4) Palladium Electroplating

The ABS plastic plate obtained in procedure (3) was immersed into a plating solution in volume equal to two times of the size of said ABS plastic plate at 25° C. (said plating solution contained diammine dichloropalladium (II), 20 g/l of ammonium chloride, and 45 g/l of ammonia; the concentration of palladium ion in said plating solution was 0.02 mol/l; and the pH of said plating solution was adjusted to 8) as the cathode, and a palladium plate was used as the anode. A direct current power was switched on, and the electroplating was carried out at a current density of 0.5 A/dm² for 3 min. And then, said ABS plastic plate coated with palladium was taken out, and washed with deionized water, till no acid ion was detected in the washing deionized water, to obtain palladium electroplated layer in a thickness of 0.3 μm.

### (5) Chromium Electroplating

The ABS plastic plate obtained in procedure (4) was immersed into a plating solution in volume equal to two times of the size of said ABS plastic plate at 35° C. (said plating solution contained 175 g/l of chromic anhydride and 1.5 ml/l of concentrated sulfuric acid) as the cathode, and a chromium plate was used as the anode. A direct current power was switched on, and the electroplating was carried out at a current density of 3 A/dm² for 3 min. And then, said ABS plastic plate coated with chromium was taken out, and washed with deionized water, till no acid ion was detected in the washing deionized water, to obtain chromium electroplated layer in a thickness of 0.3 μm. Then, the electroplated ABS plastic plate was dried at 50° C. for 25 min., to obtain the ABS plastic product with plated layers in a total thickness of 15.8 μm.

### Example 2

This example describes the electroplated product and the preparation method provided in the present invention.

The ABS plastic plate was electroplated in the same manner as described in example 1, except that in procedure (4), said ABS plastic plate was immersed into a plating solution in volume equal to two times of the size of said ABS plastic plate at 40° C. (said plating solution contained diammine dichloropalladium (II) and cobaltous chloride; the concentration of palladium ion in said plating solution was 0.02 mol/l, and the concentration of cobalt ion was 0.006 mol/l) as the cathode, and a palladium plate was used as the anode. The electroplating was carried out at a current density of 4 A/dm² for 5 min., to obtain Pd—Co alloy electroplated layer in a thickness of 0.6 μm. The plated layers of the obtained ABS plastic product had a total thickness of 16.1 μm.

### Example 3

This example describes the electroplated product and the preparation method provided in the present invention.

The ABS plastic plate was electroplated in the same manner as described in example 1, except that in procedure (4), said ABS plastic plate was immersed into a plating solution in volume equal to two times of the size of said ABS plastic plate at 40° C. (said plating solution contained copper sulfate and tin sulfate; the concentration of copper ion in said plating solution was 0.15 mol/l, and the concentration of tin ion was 0.2 mol/l) as the cathode, and a tin plate was used as the anode. The electroplating was carried out at a current density of 2 A/dm² for 10 min., to obtain Cu—Sn alloy electroplated layer in a thickness of 3 μm. Furthermore, in procedure (5), the ABS plastic plate was immersed into a plating solution in volume equal to two times of the size of said ABS plastic plate at 25° C. (said plating solution is chromium chloride solution; and the concentration of chromium ion in said plating solution was 25 g/l) as the cathode, and a graphite plate was used as the anode. The electroplating was carried out at a current density of 1.5 A/dm² for 6 min., to obtain chromium electroplated layer in a thickness of 0.5 μm. The plated layers of the obtained ABS plastic product had a total thickness of 18.7 μm.

### Example 4

This example describes the electroplated product and the preparation method provided in the present invention.

The base material was electroplated in the same manner as described in example 1, except that said base material was a stainless steel plate having a dimension of 5 cm×5 cm×0.5 cm; after being deoiled with the method described in example 1, the base material is electroplated with copper directly with the method described in procedure (3) in example 1. In procedure (4), the stainless steel plate was immersed into a plating solution in volume equal to two times of the size of said stainless steel plate at 45° C. (said plating solution contained rhodium sulfate and nitro-ruthenium chloride; the concentration of Rh ion in said plating solution was 0.01 mol/l; the concentration of said Ru ion was 0.004 mol/l) as the cathode, and a Ru plate was used as the anode. The electroplating was carried out at a current density of 4 A/dm² for 7 min., to obtain Ru—Rh alloy electroplated layer in a thickness of 0.4 μm. The plated layers of the obtained stainless steel product had a total thickness of 15.7 μm.

### Example 5

This example describes the electroplated product and the preparation method provided in the present invention.

The ABS plastic plate was electroplated in the same manner as described in example 1, except that in said procedure (4), before the electroplating, diamond particles having an average particle diameter of 80 nm were added at 8 g/l concentration and aluminum oxide particles having an average particle diameter of 100 nm were added at 8 g/l concentration into said Pd plating solution, and the mixture was agitated homogeneously. Furthermore, a Ru—Ir alloy plate covered with Ti was used as the anode. The electroplating was carried out at a current density of 4 A/dm² for 7 min. in the plating solution at 55° C. under continuous agitation, to obtain Pd electroplated layer in a thickness of 0.5 μm. The plated layers of the obtained ABS plastic product had a total thickness of 16 μm.

### Example 6

This example describes the electroplated product and the preparation method provided in the present invention.

The ABS plastic plate was electroplated in the same manner as described in example 1, except that in procedure (4), said ABS plastic plate was immersed into a plating solution in volume equal to two times of the size of said ABS plastic plate at 50° C. (said plating solution was rhodium sulfate solution; and the concentration of Rh ion was 0.01 mol/l) as the cathode, and a Ru—Ir alloy plate covered with Ti was used as the anode. Before the electroplating, nanometer silicon dioxide particles having an average particle diameter of 90 nm were added at 10 g/l concentration into said plating solution, and the mixture was agitated homogeneously. The electroplating was carried out at a current density of 2.5 A/dm² for 5 min. in the plating solution under continuous agitation, to obtain rhodium electroplated layer in a thickness of 0.3 μm. The plated layers of the obtained ABS plastic product had a total thickness of 15.8 μm.

### Example 7

This example describes the electroplated product and the preparation method provided in the present invention.

The ABS plastic plate was electroplated in the same manner as described in example 2, except that before the electroplating, titanium oxide particles having an average particle diameter of 80 nm were added at 8 g/l concentration and aluminum oxide particles having an average particle diameter of 100 nm were added at 15 g/l concentration into the plating solution in procedure (4) and procedure (5) respectively, and the mixture was agitated homogeneously. And then the electroplating in the plating solution was carried out under continuous agitation, to obtain Pd—Co alloy electroplated layer in a thickness of 0.6 μm and chromium electroplated layer in a thickness of 0.3 μm. The plated layers of the obtained ABS plastic product had a total thickness of 16.1 μm.

### Example 8

This example describes the electroplated product and the preparation method provided in the present invention.

The ABS plastic plate was electroplated in the same manner as described in example 4, except that in procedure (4), the stainless steel plate was first immersed into a plating solution in volume equal to two times of the size of said stainless steel plate at 50° C. (said plating solution contained rhodium sulfate and nitro-ruthenium chloride; the concentration of Rh ion in said plating solution was 0.02 mol/l; and the concentration of Ru ion was 0.005 mol/l), to electroplate for 5 min.; and then, immersed into a plating solution in volume equal to two times of the size of said stainless steel plate at 50° C. (said plating solution contained diammine dichloropalladium (II), 20 g/l of ammonium chloride, and 45 g/l of ammonia; the concentration of Pd ion in said plating solution was 0.02 mol/l; and the pH of said plating solution was adjusted to 8) as the cathode, a Ru—Ir alloy plate covered with Ti was used as the anode, and electroplated for 5 min. at a current density of 3 A/dm², to obtain nickel substitute electroplated layer in a thickness of 0.7 μm. The plated layers of the obtained stainless steel product had a total thickness of 16 μm.

### Example 9

This example describes the electroplated product and the preparation method provided in the present invention.

The ABS plastic plate was electroplated in the same manner as described in example 1, except that procedure (5) was not carried out, i.e., after Pd electroplating, the electroplated ABS plastic plate was dried for 25 min. at 50° C. The plated layers of the obtained ABS plastic product had a total thickness of 15.5 μm.

### Comparative Example 1

This comparative example is used to describe the electroplated product of the prior art.

The ABS plastic plate was electroplated in the same manner as described in example 1, except that in procedure (4), said ABS plastic plate was immersed into a plating solution in volume equal to two times of the size of said ABS plastic plate at 25° C. (said plating solution was nickelous sulfate solution; and the concentration of Ni ion was 1.0 mol/l) as the cathode, and a nickel plate was used as the anode, to obtain nickel electroplated layer in a thickness of 6 μm. The plated layers of the obtained ABS plastic product had a total thickness of 21.5 μm.

### Comparative Example 2

This comparative example is used to describe the existing electroplated products.

The ABS plastic plate was electroplated in the same manner as described in example 4, except that in procedure (4), said stainless steel plate was immersed into a plating solution in volume equal to two times of the size of said stainless steel plate at 45° C. (said plating solution was nickelous sulfate solution; and the concentration of Ni ion was 0.8 mol/l) as the cathode, and a nickel plate was used as the anode, to obtain nickel electroplated layer in a thickness of 5 μm. The plated layers of the obtained stainless steel product had a total thickness of 20.3 μm.

### Electroplated Layer Performances Test

The electroplated products obtained in examples 1-9 and comparative examples 1-2 were subjected to salt-spray resistance test, wearing resistance test, and thermal shock resistance test as follows. The results were shown in Table 1.

The wearing resistance test was carried out with 7-IBB RCA wearing testing machine from Norman Instrument and Equipment Co., Ltd. (USA) under 175 g wearing force, till the base material was exposed. And then, the number of revolutions of the rubber wheel was recorded. The salt-spray resistance test was carried out as follows: the electroplated product was put into a salt fog cabinet, and sprayed with 5 wt % sodium chloride solution at 35° C. for 2 h. Then the electroplated product was taken out from the salt fog cabinet, and put into a humidity test chamber at 40° C. and 80% relative humidity. The electroplated product was observed and the time when its surface became abnormal.

The thermal shock resistance test was carried out as follows: the electroplated product was put into a thermal shock test cabinet. The test temperature was reduced to −40° C., and the electroplated product was kept for 2 h. Then, the test temperature was raised to 85° C. within 3 min, and the electroplated product was kept for 2 h. The above operations was carried out for 5 cycles, and then, the electroplated product was put in a room temperature environment, to observe whether there is any abnormality on the surface of said electroplated product.

TABLE 1

| | Wearing | Salt-spray | |
|---|---|---|---|
| | resistance | resistance | |
| Example No. | (cycle) | (h) | Thermal shock |
| Example 1 | 1,900 | 168 | Pass, no abnormality |
| Example 2 | 2,000 | 168 | Pass, no abnormality |
| Example 3 | 2,100 | 168 | Pass, no abnormality |
| Example 4 | 2,050 | 168 | Pass, no abnormality |
| Example 5 | 2,900 | 192 | Pass, no abnormality |
| Example 6 | 3,000 | 180 | Pass, no abnormality |
| Example 7 | 3,000 | 180 | Pass, no abnormality |
| Example 8 | 2,000 | 172 | Pass, no abnormality |
| Example 9 | 1,850 | 168 | Pass, no abnormality |
| Comparative | 1,800 | 168 | Pass, no abnormality |
| Example 1 | | | |
| Comparative | 1,500 | 168 | Pass, no abnormality |
| Example 2 | | | |

It could be seen from the data in Table 1 that: compared with the electroplated products having nickel electroplated layer obtained in comparative examples 1-2, the electroplate products having nickel substitute metal electroplated layer obtained in examples 1-4 and 8-9 of the present invention are much superior in wearing resistance, and are equivalent or superior in salt-spray resistance and thermal shock resistance. Compared with the electroplated products having nickel electroplated layer obtained in comparative examples 1-2, the electroplate products having nickel substitute metal electroplated layer obtained in examples 5-7 in which nanometer particles were added into the plating solution is even more superior in wearing resistance and superior in salt-spray resistance.

1-13. (canceled)

14. An electroplated product, comprising:
a base;
a copper layer on the base; and
an electroplated metal layer on the copper layer, wherein the electroplated metal layer is selected from a group consisting of Cu—Sn alloy, Rh, Ru, Pd, and an alloy comprising at least two elements of Ru, Rh, Pd, and Co.

15. The electroplated product of claim 14, wherein the copper layer has a thickness of about 10-30 μm.

16. The electroplated product of claim 14, wherein the electroplated metal layer has a thickness of about 0.1-6 μm.

17. The electroplated product of claim 14, wherein the electroplated metal layer further comprises nano particles.

18. The electroplated product of claim 17, wherein the nano particles are selected from a group consisting of diamond particles, aluminum oxide particles, silicon dioxide particles, titanium dioxide particles, zirconium oxide particles, and combinations thereof.

19. The electroplated product of claim 17, wherein the nano particles have a particle diameter of about 50-200 nm.

20. The electroplated product of claim 14, wherein the base comprises a non-conductive material.

21. The electroplated product of claim 20, wherein the base comprises a plastic material.

22. The electroplated product of claim 20, further comprising a metal layer between the base and the copper layer.

23. An electroplated product, comprising:
a base;
a copper layer on the base;
an electroplated metal layer on the copper layer, wherein the electroplated metal layer is selected from a group consisting of Cu—Sn alloy, Rh, Ru, Pd, and an alloy comprising at least two elements of Ru, Rh, Pd, and Co; and
a chromium layer on the electroplated metal layer.

24. The electroplated product of claim 23, wherein the chromium layer has a thickness of about 0.1-0.5 μm.

25. The electroplated product of claim 24, wherein the chromium layer further comprises nano particles.

26. The electroplated product of claim 25, wherein the nano particles are selected from a group consisting of diamond particles, aluminum oxide particles, silicon dioxide particles, titanium dioxide particles, zirconium oxide particles, and combinations thereof.

27. The electroplated product of claim 24, wherein the nano particles have a particle diameter of about 50-200 nm.

28. A method for preparing an electroplated product, comprising:
electroplating a copper layer onto a base; and
electroplating a metal layer onto the copper layer, wherein the electroplated metal layer is selected from a group consisting of Cu—Sn alloy, Rh, Ru, Pd, and an alloy comprising at least two elements of Ru, Rh, Pd, and Co.

29. The method of claim 28, wherein the metal layer is electroplating from an aqueous plating solution; wherein the aqueous plating solution comprises a salt selected from the group consisting of Cu—Sn, Ru, Rh, Pd, and a salt comprising at least two elements of Ru, Rh, Pd, and Co.

30. The method of claim 29, wherein the aqueous plating solution has a metal ions concentration of about 0.001-0.5 mol/L.

31. The method of claim 29, wherein the plating solution further comprises nano particles.

32. The method of claim 31, wherein the aqueous plating solution comprises nano particles in a concentration of about 5-30 g/L.

33. The method of claim 31, wherein the nano particles have a particle diameter of about 50-200 nm.

34. The method of claim 31, wherein the nano particles are selected from a group consisting of diamond particles, aluminum oxide particles, silicon oxide particles, titanium dioxide particles, zirconium oxide particles, and combinations thereof.

35. The method of claim 28, wherein the base comprises a non-conductive material.

36. The method of claim 35, wherein the method further comprises a metal plating before the electroplating of the copper layer.

37. The method of claim 28, further comprising electroplating a chromium layer onto the electroplated metal layer.

38. The method of claim 37, wherein the chromium layer is electroplated from a plating solution comprising nanometer particles.
